(19) United States
(12) Patent Application Publication
(10) Pub. No.: US 2026/0369256 A1
(43) Pub. Date: Nov. 19, 2026

(54) SYSTEM AND METHODS FOR REAL-TIME, AI-DRIVEN MUSICAL INTERACTION

(71) Applicant: Massachusetts Institute of Technology, Cambridge, MA (US)

(72) Inventors: Lancelot Blanchard, Le Theil-de-Bretagne (FR); Perry Naseck, Somerville, MA (US); Joseph A. Paradiso, Medford, MA (US); Cheng Zhi Huang, Cambridge, MA (US); Jordan Charles RUDES, New City, NY (US)

(73) Assignee: Massachusetts Institute of Technology, Cambridge, MA (US)

(21) Appl. No.: 19/676,230

(22) Filed: May 13, 2026

Related U.S. Application Data
(60) Provisional application No. 63/805,503, filed on May 14, 2025.

(51) Int. Cl. G10H 1/00; G06F 40/40

(52) U.S. Cl. CPC G10H 1/0025; G06F 40/40; G10H 2210/076; G10H 2210/105; G10H 2210/111; G10H 2210/391

(57) ABSTRACT

Described is a real-time performance system configured to match eclectic improvisational aesthetics of a performer. The system is capable of realizing a series of virtuosic tightly-coupled human-AI improvisations in varying musical styles. The real-time performance system configured is configured to: (a) to take on different musical roles, such as lead, accompany, or engage in call and response by adapting music language models (LMs) to take on different interaction strategies by modifying the context and conditioning signals they take in; (b) to match a style needed for each piece, one or more music LMs to enable the different interaction strategies; and (c) run music LMs in real-time and embed them in a low-latency multi-threaded system that listens, and prompts and schedules model generations.

### CROSS-REFERENCE TO RELATED APPLICATIONS

This application claims benefit of U.S. Provisional Patent Application No. 63/805,503, filed May 14, 2025, the entirety of which is incorporated herein by specific reference.

### FIELD

The present disclosure generally relates to machine learning systems for musical inputs, and more particularly to machine learning systems that generate musical outputs based on musical inputs.

### BACKGROUND

Generative AI techniques have been increasingly prominent in the field of music production and composition. For example, companies like Udio, Suno, or Stable Diffusion have all recently released models capable of generating music of high sonic quality. Additionally, open-source models and architectures, like the Music Transformer (or variations, like the Anticipator Music Transformer), offer a similar ability to generate high-quality symbolic music. Also, the Digitech Trio+ is a guitar effects pedal that will train on a line of chords or melody that are played into it, and then subsequently, using conventional music information retrieval techniques, generate and play an appropriate backing track to jam over. However, all of these tools lack the ability to operate in real-time.

Some systems have integrated the automatic generation of music within real-time systems, although they suffer from three major limitations. First, they are constrained on specific generation tasks (e.g., continuation, harmonization, etc.) and are unable to flexibly adapt to the needs of a user in real-time. Second, they can only be interacted with in one specific way and cannot properly model the interactive modalities of collective improvision between human actors. Third, they do not scale up to accommodate large neural networks, which as described below, offer more accurate musical sampling and generation.

Musical input processing has long been an active area of research and development, encompassing applications in areas such as speech synthesis, music generation, audio enhancement, voice conversion, etc. Traditional approaches rely heavily on deterministic musical input processing techniques, including, but not limited to, Fourier based transformations, filtering/estimation, and rule-based synthesis. Additionally, approaches may include, but are not limited to, hidden Markov modeling, gaussian mixture models, conditional random fields, dynamic Bayesian networks, recurrent neural networks, connection temporal classification, etc. While effective in certain scenarios, such approaches often lack the flexibility and ability to capture the complex temporal and spectral structure of real-time musical inputs.

### SUMMARY

Described herein is a real-time generative artificial intelligence (AI) system utilizing music Language Models (LMs) to facilitate collaborative improvisation with a performer. In improvisation, musicians may perform without a predefined musical score or structure, although embodiments described herein are not limited to a musical inputs and music generation with or without a predefined musical score or structure.

The system is a real-time performance system configured to match particular improvisational aesthetics of a performer.

The real-time performance system is capable of realizing a series of virtuosic tightly-coupled human-AI improvisations in varying musical styles. The real-time performance system is configured to: (a) to take on different musical roles, such as lead, accompany, or engage in call and response by adapting music language models (LMs) to take on different interaction strategies by modifying the context and conditioning signals they take in; (b) match a style needed for each piece by fine-tuning one or more music LMs to enable the different interaction strategies; and (c) run music LMs in real-time and embed them in a low-latency multi-threaded system that listens, and prompts and schedules model generations.

In one embodiment, the system utilizes interaction strategies to guide real-time prompting of the music LM, along with selecting and refining the necessary training data. Also described is an optimized system in which to embed the music LMs and run them in real-time.

Rather than working with generative AI off-stage in an off-line fashion, the concepts, systems and techniques described herein allow a performer (e.g., a musician or group of musicians) to improvise on stage, in a studio, etc., in real-time.

In accordance with a further aspect of the concepts disclosed herein, also described is a technique for training music LMs for use in a real-time performance system to generate human-AI improvisations in varying musical styles.

The concepts, systems and techniques described herein can foster more collaborations between AI systems and performers and inspire future development of generative AI music systems for use in live music performances. Additional interaction strategies, particularly through the use of Reinforcement Learning, could enhance the system's responsiveness to external musical input. Additionally, improvements may be made by enabling expressive MIDI or other musical outputs that go beyond issuing simple note commands and extending the capabilities to planned improvisation.

In an embodiment, a method and/or system for real-time artificial intelligence (AI) drive musical interaction is provided. A global clock may be received. One or more musical input signals may be received. The one or more musical input signals may be processed using the global clock to generate one or more musical events. One or more music language models (LMs) may be updated based on the generated one or more musical events. A LM musical output may be generated in response to a prompt being triggered. The LM musical output may be generated using at least a portion of the one or more musical events and the one or more music LMs. The generated LM musical output may be synchronized based on the global clock. The synchronized generated LM musical output may be output.

In an embodiment, the one or more music LMs may be generated the LM musical output using autoregressive generation. In an embodiment, the generated LM musical output may be an audio output. In an embodiment, the generated LM musical output may be one or more musical events. In an embodiment, the one or more musical events may be one or more notes. In an embodiment, the prompt may be a time interval. In an embodiment, the time interval may be one or more bars. In an embodiment, the prompt may be a musical gesture. In an embodiment, the musical gesture may be a root note. In an embodiment, the prompt may be a user input. In an embodiment, the user input may be selected from the group consisting of: physical manipulation of a musical pedal, input to a keyboard, input to a mouse, a physical gesture of a user, and a text prompt. In an embodiment, the prompt may be determined based on the one or more musical input signals diverging from the generated LM musical output. In an embodiment, the one or more musical events may be selected from the group consisting of: harmonic content, melodic content, and rhythmic content. In an embodiment, the generated LM musical output may be stored in response to receive a user input. In an embodiment, the generated LM musical output may be cleared in response to receiving a user input. In an embodiment, the receive one or more musical input signals may be audio. In an embodiment, the one or more music LMs may be modified based on a user input.

### BRIEF DESCRIPTION OF THE DRAWINGS

This application contains at least one drawing executed in color. Copies of this patent or patent application publication with color drawing(s) will be provided by the Office upon request and payment of the necessary fee.

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principles of the concepts described herein. Like reference numerals designate corresponding parts throughout the different views. Furthermore, embodiments are illustrated by way of example and not limitation in the figures, in which:

FIG. 1 is a block diagram of a device for utilizing music language models (LMs) to facilitate collaborative improvisation based on an input.

FIG. 2 is a flow diagram of a process utilizing music LMs to facilitate collaborative improvisation based on an input.

FIGS. 3A-3E are plots which illustrate different example input strategies which may be used to prompt a music LM at regular time intervals (FIG. 3A), at a melodic musical gesture (FIG. 3B), at a harmonic musical gesture (FIG. 3C), at continuous prompting (FIG. 3D), and manual prompting upon request (FIG. 3E).

FIG. 4 is a block diagram of an example system which utilizes different parallel processes to facilitate collaborative improvisation with a performer.

FIG. 5 is a plot of the annotation process of the call and response model. The recorded MIDI file is segmented into two instruments using the signal of Continuous Control, as recorded by a MIDI foot switch.

FIG. 6 is a block diagram of an example of a cloud computing environment in which various aspects of the disclosure may be implemented.

FIG. 7 is a block diagram of an example of a computing system that may be used to implement one or more of the components of the computing environment shown in FIGS. 1 and 4.

### DETAILED DESCRIPTION

Embodiments of the present invention provide improvements to current music generation system by exploring how autoregressive symbolic music Language Models (LMs) could be adapted into musical improvisation system 120 enabling virtuosic, tightly-coupled Human-AI improvisation. Although music LMs, from Music Transformers to Anticipatory Music Transformers, can generate compelling musical sequences, their outputs are often generic, their inference speeds too slow, and their input, output, and conditioning structures too rigid. To support highly-entangled Human-AI improvisations where musical role-switching is frequent, mechanisms for coordination or signaling are essential. Additionally, the JAM_BOT (i.e. musical improvisation system 12) also needs to pay “double attention” to both what the human musician is playing and its own past, present, and future performances.

First, interaction strategies were developed for the musical improvisation system 120 enabling the system to take on different musical roles in the improvisation and the musician to shape the musical outcome.

Second, for musical improvisation system 120 to match the style and identity needed for each piece, described below is how a performer intentionally structures his improvisation in order to finetune music LMs to enable the aforementioned interaction strategies and model stylistic gestures.

Third, below are shown the optimizations needed to run music LMs in real-time and how to embed them in a low-latency multi-threaded system that listens and prompts and schedules model generations seamlessly.

In accordance with a further aspect of the concepts disclosed herein, also described are interactions enabling offline algorithmic composition. Such offline techniques offer new inspiration to composers and amateurs alike in environments where low latency is of little importance.

In accordance with a further aspect of the concepts disclosed herein, also described are systems designed for real-time musician-machine collaboration. Real-time human-machine collaboration focuses on live scenarios like performance and improvisation. The system described herein adopts key offline symbolic music modeling advancement, for example the Anticipatory Music Transformer (AMT), to enable unique real-time interactions that support comprehensive and controllable improvisation.

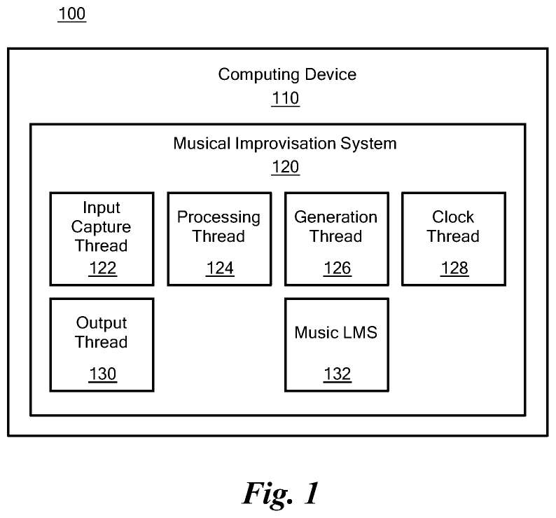

Referring now to FIG. 1, an example system 100 includes a computing device 110 comprising a musical improvisation system 120 which may be implemented in hardware, software or by a combination of hardware and software. Thus, musical improvisation system 120 is sometimes referred to herein as a musical improvisation program 120. In the example embodiment of FIG. 1, musical improvisation system 120 includes an input capture thread 122, a processing thread 124, a generation thread 126, a clock thread 128, an output thread 130 and one or more language music (LM) models 132. It should be noted, in a preferred embodiment, input capture thread 122, processing thread 124, generation thread 126, clock thread 128, output thread 130, and one or more LM models 132 are found on the same computer device, for example computing device 110. In alternative embodiments, each of input capture thread 122, processing thread 124, generation thread 126, clock thread 128, output thread 130, and one or more LM models 132 may be found on separate devices, for example more than one computing device 110. In yet another alternative embodiment, some of input capture thread 122, processing thread 124, generation thread 126, clock thread 128, output thread 130, and one or more LM models 132 may found on a first computing device, for example computing device 110, and some of input capture thread 122, processing thread 124, generation thread 126, clock thread 128, output thread 130, and one or more LM models 132 may be found on another computing device (not shown). In these alternative embodiments, the computing devices may communication with each other via a network (e.g. the internet) or in a cloud computing environment (which may also be referred to as a cloud environment, cloud computing or cloud network), as discussed below.

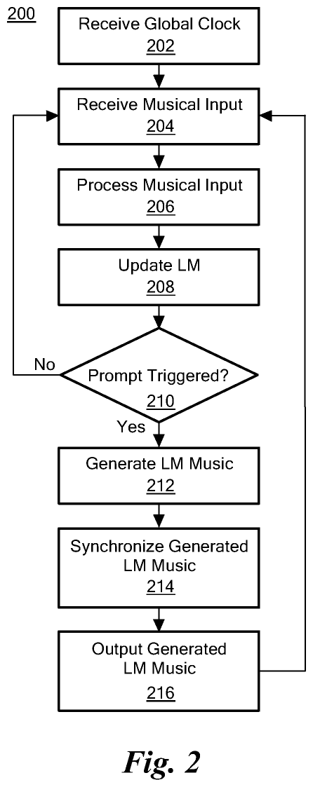

FIG. 2 is a flow diagram showing example processing to utilize music LMs to facilitate collaborative improvisation based on a user input. Rectangular elements (typified by element 202 in FIG. 2), denoted as “processing blocks,” represent computer software instructions or groups of instructions. Diamond shaped elements (typified by element 210 in FIG. 2), are herein denoted “decision blocks,” and represent computer software instructions, or groups of instructions, which affect the execution of the computer software instructions represented by the processing blocks. Alternatively, the processing and decision blocks may represent functions performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown.

It will be appreciated by those of ordinary skill in the art that unless otherwise indicated, the particular sequence of the described processing is illustrative only and can be varied without departing from the spirit of the concepts, structures, and techniques described. Thus, unless otherwise stated the processes described below are unordered meaning that, when possible, the functions represented by the processing and decision blocks can be performed in any convenient or desirable order.

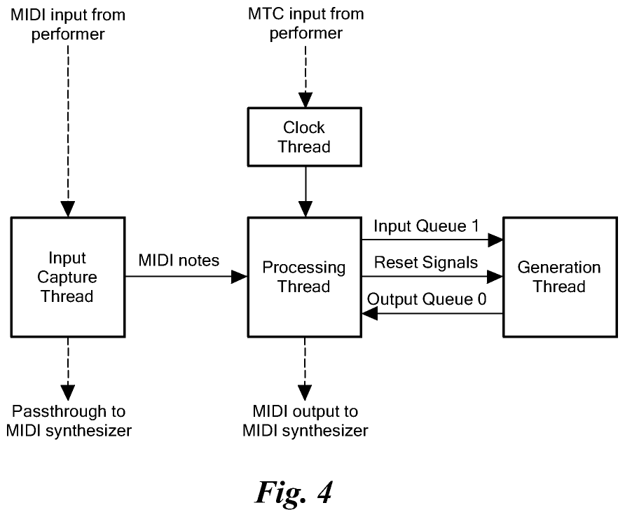

It should be appreciated the described processing may be performed by a system which is the same as or similar to the systems of FIGS. 1 and 4.

Turning now to FIG. 2, processing to utilize music LMs to facilitate collaborative improvisation with a musical input, as shown in flowchart 200. In an embodiment, each processing block(s)/decision block(s) of flowchart 200 is processed and performed by musical improvisation system 120 and/or threads, for example input capture thread 122, within musical improvisation system 120. As noted above, in a preferred embodiment, each processing block(s)/decision block(s) of flowchart 200 is performed on computing device 110 but embodiments of the present invention recognize that some processing block(s)/decision block(s) may be performed by another program/thread on another computing device, not shown.

In an embodiment, processing begins with processing block 202 in which a global clock is received by musical improvisation system 120. In an embodiment, the global clock may be an internal clock from computing device 110, for example the clock system for computing device 110 or the clock associated with processor(s) 902. In an embodiment, the global clock may be received from another device (not shown) via communication interface(s) 910, discussed below. Here the global clock may be from, for example, an audio processing device. In an embodiment, the global clock may be in the form of a MIDI Timecode (MTC), OSC messages, SMPTE time source, wall clock time source, etc., and embodiments of the present invention recognize that any other global clock may be employed as known in the art. In an embodiment, the global clock may be a timer that allows computing devices to communicate and output music at an accurate time based on a musical input. In an embodiment, the global clock may be received and processed by input capture thread 122 and then transferred to clock thread 128 in order to maintain an accurate global clock for received musical input and output generated music. In an alternative embodiment, the global clock may be received directly by clock thread 128.

In an embodiment, processing proceeds to processing block 204 in which a musical input is received 204. In an embodiment, the musical input may be any symbolic or continuous source of musical input. In an embodiment, the musical input may be in the form of a musical instrument digital interface (MIDI). In an embodiment, MIDI is the technical standard that allows musical instruments, computers, and other electronic devices to communicate performance data, including but not limited to which notes are played, how hard or fast each note is played, how long each note is played, etc. In an embodiment, the musical input may be in the form of open sound control (OSC). In an embodiment, the musical input may be notes derived from processed music signals. In an embodiment, the musical input may be in any form of music, including but not limited to audio, MIDI, visual, etc. In an embodiment, the audio may be in the form of WAV, MP3, AIFF, etc. In an embodiment, the musical input may be in the form of a visual representation of music, including but not limited to an image/video of sheet music, an image/video of music being played, etc. In an embodiment, the musical input may be in the form of a textual representation of music, for example a document that describes notes played and timing for when the notes are played, type/style of music being played, etc. In an embodiment, the musical input may be files, complete static sources, and/or recordings. In an embodiment, the musical input may be live music provided in real-time to musical improvisation system 120. In an embodiment, the live music may be provided as MIDI data, streaming audio, etc. In an embodiment, the musical input may include physical inputs, such as buttons being triggered/pressed/depressed, physical gestures, and/or other dynamic inputs that allow for musical communication with the musical improvision system 120. In an embodiment, the musical input is received by input capture thread 122.

In an embodiment, processing proceeds to processing block 206 in which musical input is processed into one or more musical events. In an embodiment, a musical event may be a single note. Here, the single notes may be processed into a tuple of tokens. For example, the single notes may be processed into a tuple of tokens, including but not limited to: onset time, duration, note, instrument and note velocity. In an embodiment, note velocity is the speed at which a key or an audio input pad is struck, for example a faster strike is a higher velocity and vice versa a slower strike is a slower velocity, which is typically represented as a value from 0 to 127 in MIDI files. Further discussion of note velocity is found below. In an embodiment, the musical event may be a plurality of notes.

In an embodiment, the musical input may be converted into a learning model architecture, including but not limited to Performance RNN, Music Transformers, AGPT-2-based Anticipator Music Transformer (AMT), etc. In an embodiment, the musical input may be processed into one or more notes, melodic gestures, harmonic gestures, root note, etc. In an embodiment, melodic gestures are two or more notes that provide melodic function in music. In an embodiment, harmonic gestures are two or more notes that provide harmonic function in music. In an embodiment, the musical input is processed by processing thread 124.

In an embodiment, processing proceeds to processing block 208 in which the one or more music learning model(s) (LM) are updated using the processed musical input and a global clock. In an embodiment, the global clock may be the received global clock in processing block 202. In an alternative embodiment, the global clock may be an internal global clock and not necessarily received in processing block 202. In an embodiment, the music LMs are updated using music LMs 132. In an embodiment, the content of the music LMs 132 may be continually updated based on the received musical input of processing block 204. In an embodiment, the content of the music LMs 132 may not be updated continually and generated LM music, described in processing block 212 below, may be done based on one or more pre-defined music LMs 132. In an embodiment, the music LMs 132 may be any music LM model known in the art. In an embodiment, the music LMs 132 may be an AMT model. In an embodiment, the music LMs 132 may be any model that allows for modeling music. In an embodiment, the music LM is updated by processing thread 124, generation thread 126, and/or music LMs 132.

In an embodiment, the music LMs 132 may be initially trained and updated before initialization of flowchart 200. In an embodiment, the music LMs 132 may be trained by providing one or more musical inputs that include one or more chords, one or more melodies, or any other musical input. In an embodiment, one or more music LMs 132 may be associated with a specific genre of music (e.g., jazz, classical, etc.) or a specific playing style within that genre, may be associated with a group of genres of music (e.g., both jazz and classical), may be associated with a specific user or users (e.g. an artist, a performer, a band, an orchestra, etc.), may be associated with a predefined subset of musical input, etc.

In an embodiment, the music LMs 132 may be trained by additional user input markers, such as training music that includes a subset of calls and responses, further discussed below. Additionally, input markers may include, but is not limited to, parts of music (e.g., chorus, verse, bridge, etc.) and instrument position (e.g., lead, rhythm, bassline, etc.). In an embodiment, the music LMs 132 may be trained by music that is input that has “call” music and “response” music. In this embodiment, user input may (e.g. depression of a MIDI foot switch, for example) indicate “call” music and user input (e.g. release of a MIDI foot switch) indicate “response” music. This allows the training model to realize and understand what music is being generated in response to input music even if the user is performing both the “call” and the “response”. In other words, a user acts as the expert, choreographing the music roles of a “call” and “response” at training time which allows for more fine tuning when performing live. In another embodiment, the music LMs 132 may be trained by music that has multiple parts of music being played at the same time or near the same time, and the music has multiple parts of music input markers. As an example, the music has a first part of the music, for example a chorus, and a second part of the music, for example a verse. This allows for the music LMs 132 to be trained on different parts of music being played at the same or near same time. In another embodiment, the music LMs 132 may be trained by music that has multiple instrument positions being played at the same time or near the same time, and the music has multiple instrument position input markers. As an example, the music has a first instrument position, for example a lead, and a second instrument position, for example a bassline. This allows for the music LMs 132 to be trained on different instrument positions being plated at the same or near the same time.

In one example embodiment, to fine-tune a music LM to enable desired interaction, single-instrument MIDI clips are collected. Through this fine-tuning, the model is able to learn how to continue any sequence of musical input in a specific style, making it a good fit for this type of prompting strategy. In embodiments, the mechanism may be uses to create two pieces with greatly contrasting styles—e.g., a progressive rock piece, and a contrapuntal baroque one, where a performer (e.g. a musician and the musical improvisation system 120 described herein) are able to trade off each other.

In an embodiment, processing proceeds to decision block 210 in which it is determined whether a prompt is triggered 210. In an embodiment, the prompt may be a fixed time frame. For example, every thirty seconds the prompt is triggered. Here, the musical input is thirty seconds (i.e., the musical performer plays for 30 seconds). In an embodiment, the prompt may be a time frame of musical input. For example, every 2 bars, 4 bars, etc. of music. In another example, the prompt is triggered when music is not played for a period of time. Here, if the musical input stops for a set time period (e.g. two seconds), the prompt is triggered. In an embodiment, the prompt may be a user input. For example, a physical manipulation of a musical pedal, an input into a computer input/out device including but not limited to a keyboard or mouse, a head nod, a hand gesture, etc. It should be noted, in an embodiment, physical gestures may by a user may be determined based on methods known in the art, including but not limited to, computer vision models that are trained to detect specific user interactions with a computing device. In an embodiment, the prompt may be if a fixed pattern or type of music is determined within the received musical input. For example, a note, a duration of a note, a note release, a note velocity, bars of music, etc. In an embodiment, the prompt may be a text prompt. For example, a user, via a user interface (not shown) of computing device 110, may be able to type into the user interface “Start playing now.”, and the text may be analyzed to determine a prompt using text processing methods known in the art. Another, non-limiting, set of examples for text prompts include “Start playing when the music slows down,” or “Start playing when the melody changes key.” In an embodiment, determining whether a prompt is triggered 210 may be done by processing thread 124.

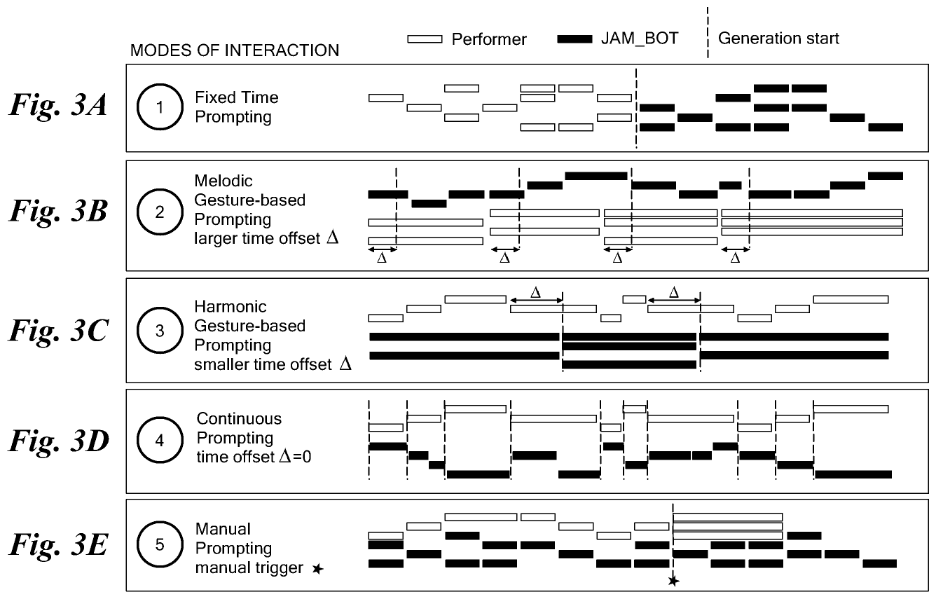

Implementing these requirements, however, is challenging. As a matter of fact, it is difficult in real-time settings to determine the optimal timing and context for prompting autoregressive models like music LMs and effectively simulating an organic conversation or musical dialogue. The speed and complexity inherent to input music make it impossible to naively prompt the model continuously, as the prompting rate would be too high to enable the generation of coherent sequences. To respond to these limitations, decisions are made on when and how to best prompt the music LM to ensure the model can create coherent outputs that also align with the performer's input. To do so, inspiration is taken from the way human improvisers continuously attend to the continuous influx of musical information from fellow players while simultaneously focusing on their own performance to construct coherent musical ideas. Norgaard et al, describe this dual-process phenomenon in expert jazz musicians, involving a conscious focus on higher-level musical elements and ensemble interaction, alongside a subcon-scious process for generating note choices. To model this phenomenon, five interaction strategies, discussed above and below, were developed to guide when the model should pay attention to external information, and when it should focus on its own composition. These strategies are illustrated at least in FIG. 3A-3E. Additionally, in order to ensure the system displays strong style adherence, precise training datasets were crafted for each interaction strategy as described above and below.

FIGS. 3A-3E illustrate different example input strategies which may be used for prompt determination. Here, a prompt occurs at regular time intervals (FIG. 3A), at every melodic musical gesture (FIG. 3B), at every harmonic musical gesture (FIG. 3C), continuous prompting (FIG. 3D), and manual prompting/on request (FIG. 3E). The example interaction strategies illustrated in FIGS. 3A, 3D, and E may provide both harmonic and melodic conditioning, FIG. 3B may provide melodic conditioning, and FIG. 3C may provide harmonic conditioning.

The interaction strategies of FIGS. 3A-3E also provide rhythmic information which is the variable timing of notes and time between notes in music. In FIGS. 3B and 3C, the symbol delta (Δ) refers to a delay parameter set to trigger melodic gesture-based prompting illustrated in FIG. 3B and the symbol delta (Δ) refers to a delay parameter set to trigger harmonic gesture-based prompting illustrated in FIG. 3C.

Referring now to FIG. 3A, the most straightforward approach to prompt the model is to do so at regular time intervals using the harmonic, melodic, and rhythmic content most recently played by the performer. In an embodiment, as described above, the model may use the harmonic, melodic, and rhythmic content played during the regular time interval to generate LM music in processing block 212, as described below. For example, if the regular time interval is ten seconds, then the model may use the last ten seconds of received musical input to generate music. In an embodiment, the predefined time interval may be related directly to the music, for example 4 bars, 2 bars, 1 bar, instead of a specific time period (i.e. seconds, minutes, etc.). Drawing from common practices in improvised music, this strategy enables the human and the system to alternate (“trade”) in their improvisation, with each yielding to the other after a predetermined time interval (e.g., 4 bars, 2 bars, 1 bar). During the system's turn, the musical improvisation system 120 focuses solely on its own output, while the musical improvisation system 120 listens to the human input when it is not playing.

Referring now to FIGS. 3B and 3C, another approach to modeling the aforementioned dual process of consciousness is by attending to every single input as it is received. Using this approach, the system listens to each note played by the user, updating its context after a brief delay (e.g., 100 ms to accommodate chord input). This strategy can be used to prompt the model with either harmonic or melodic content. For melody conditioning, a longer delay (e.g., 800 ms) is used to allow the system to react to sustained notes or to wait for a root note before re-prompting the model. Using this strategy, the system can tightly follow the harmonic or melodic decisions input by the performer before seamlessly transitioning to a leading role, until another input is received. To implement a stricter form of conditioning, the anticipatory mechanism of music LMs 132 may be used to repeatedly condition the model on the same prompt every X ms, for a given X. This effectively locks the musical improvisation system 120 into a following role, preventing it from making musical decisions. As shown in FIG. 3B, a user performs the harmony (orange bars), and the musical improvisation system 120, after the delta delay (Δ), will output the melody (blue bars). As shown in FIG. 3C, a user performs the melody (orange bars), and the musical improvisation system 120, after the delta delay (Δ), will output the harmony (blue bars).

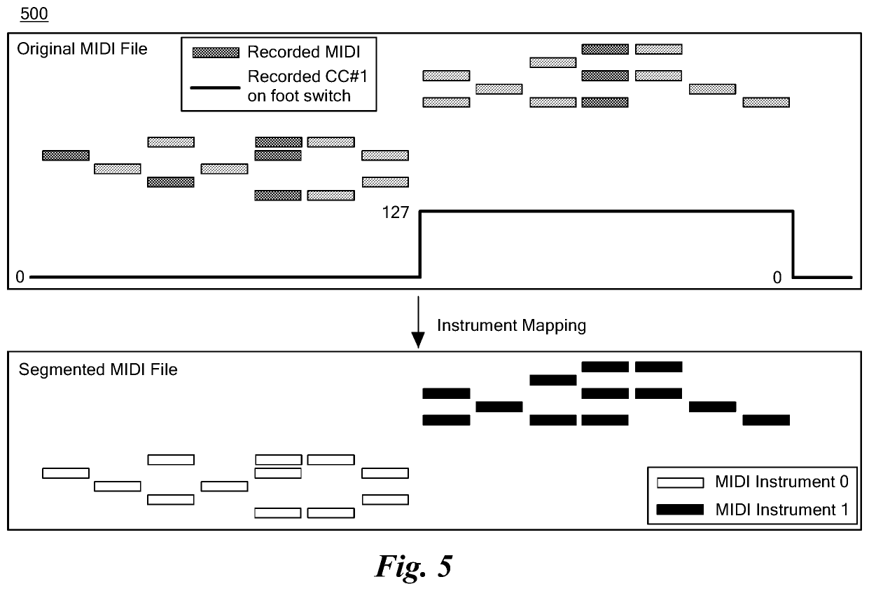

Similarly to the previous case, this type of interaction can be enabled by fine-tuning music LMs 132 on recorded MIDI clips. To model a joint distribution between the harmony/melody conditioning (conditioning signal) and the sequence to generate (input signal), MIDI files with two or more instruments—for example, represented by two different General MIDI codes, are created. In an embodiment, the two or more instruments are recorded using either different keyboard registers, or through different MIDI channels, as shown the plot 500 in FIG. 5.

For example, data may be recorded by a musician playing chords with one hand (e.g., left hand), and melodies with the other hand (e.g. right hand). Empirically, it was discovered that the best training data may be collected when the musician fixed a conditioning signal (e.g., a specific chord) for a few bars, and improvised multiple input signals over the same condition before transitioning to a new one. In the performance, a musician may play sequences of chords, dictating harmonic decisions to the musical improvisation system 120, which would freely improvise melodies on top.

Referring now to FIG. 3D, another approach to modeling the aforementioned dual process of consciousness is by attending to every single input as it is received, similar to FIGS. 3B and 3C. In this embodiment, the musical improvisation system 120 is continuously prompted, and the musical improvisation system 120 outputs music after every single note that is received by the musical input (i.e. after every note played by a user/performer). In an embodiment, the musical improvisation system 120 is able to determine when LM music should be generated, or when the musical improvisation system 120 should wait to receive more musical input (instead of systematically generating LM music after every note input).

Referring now to FIG. 3E, a hybrid approach may be employed, which allows the model to alternate explicitly between focusing on its own composition and the user input on request. With this strategy, the musical improvisation system 120 shifts its attention to the performer's main conditioning input (conditioning signal 1) upon request, triggered by a specific input (conditioning signal 2—e.g., a specific register of the keyboard, a MIDI pedal depression/release, a specific pattern of music being played, a physical gesture, etc.). Once activated, the musical improvisation system 120 may use the most recent notes stored in a buffer of predetermined size to condition its future outputs. This approach, for example, can allow the performer to play melodic lines and prompt the system to refresh its output when a root note is played in a lower octave.

The type of interaction found in FIG. 3E is slightly more complex than the interactions described in conjunction with FIGS. 3A, 3B, and 3C. In order to train music LMs and enable this interaction, it is necessary to record two or more different MIDI clips or signals, enabling the modeling of both conditioning signals. In an example performance, a performer may use this interaction strategy for a piece where the musical improvisation system 120 was able to improvise chords and basslines, while the performer may improvise melodies on top. When the performer wants to focus the model's attention on his most recent harmonic and melodic movements, the performer could hit a root note on the lowest octave of a keyboard (or other instrument) to trigger the prompting of the underlying music LM. The training data for this type of interaction may require the performer to provide two or more MIDI clips: one with pairs of chords and basslines, and one with pairs of chords and root notes. During a live performance, the performer may perform with this interaction strategy to create a musical piece where the performed improvises melodies over the musical improvisation system 120's basslines and chord progressions.

It should be noted that, to additionally ensure local coherence with a musician's input, small context windows may be used (between 40 and 60 notes) to prompt the music LM. This allows the musical improvisation system 120 to generate sequences that connect directly to the performer's input, instead of focusing on musical events that have happened in a more distant past, similar to discussed above. Alternatively, larger context windows may be used, which allows for the musical improvisation system 120 to focus on larger sets of musical events. In an embodiment, the context window size may be determined before the initialization of flowchart 200 or during any processing block or decision block of flowchart 200 via user input or any other method.

In an embodiment, in response to a prompt not being triggered, decision block 210, no branch, processing proceeds to processing block 204, as described above. In an embodiment, in response to a prompt being triggered, decision block 210, yes branch, processing proceeds to processing block 212.

In an embodiment, processing proceeds to processing block 212 in which LM music is generated. Here, the one or more music LMs 132 generate LM music. In an embodiment, the one or more music LMs 132 generate music based on all of musical input of processing block 204. In an embodiment, the one or more music LMs 132 generate music based on at least a portion of the musical input of processing block 204. Here, a predefined time period of musical input of processing block 204 is used by the one or more music LMs 132 to generate music. For example, the one or more music LMs 132 may generate music based on the last 10 seconds of received musical input or based on the last 4 bars of received musical input. In another example, a user may, via a user input such a physical depression of a MIDI foot petal, indicate a start and stop condition for defining which portion of the musical input of processing block 204 is used to generate music by the one or more music LMs 132. In an embodiment, LM music may be generated by generation thread 126.

In an embodiment, each newly generated music may cause previously generated music to be invalidated. In an alternative embodiment, each newly generated music may be dynamically evaluated against one or more previously generate music(s) to determine whether the newly generated music contradicts the previously generated music(s). In an embodiment, this can be done through a distance metric or reward model. In an embodiment, instead of triggering a new generation for every musical gesture, musical improvisation system 120 may interact with an agent trained on a reward model that can dynamically adjust when new generations should be made following a learnt policy capable of determining when an input requires a new musical future/output.

In an embodiment, the generated LM music may be in the form of a visual output. For example, the generated LM music may be visually displayed as sheet music for printing, as a visual display of music on a display device (not shown), through a stage lighting system, a sculpture, etc.

In an embodiment, processing proceeds to processing block 214 in which the generated LM music is synchronized. In an embodiment, using the global clock received in processing block 202, the generated LM music is synchronized so that when the generated LM music is output the generated LM music plays in sync with the previous input music in real-time. In an embodiment, the generated LM music is synchronized by generation thread 126, clock thread 128, and/or output thread 130.

Here, the goal of the invention is to generate future note sequences at a faster rate than they need to be played in real-time. Physically-actuated output music devices, such as a player piano, require a lead-in time to play each note. In an embodiment, the generated LM music is synchronized globally. In this embodiment, a global latency offset is configured via a user interface (not shown). In an embodiment, because the notes are generated ahead of them being played, the music improvisation system 120 takes into account the output instruments that require a lead-in time (i.e. a player piano needs to begin physically moving the key before ethe time the sound should be made), and schedules the timing of the note sequences so they are played in real-time.

In an embodiment, processing proceeds to processing block 216 in which the synchronized generated LM music is output. Here, the musical improvisation system 120 outputs the generated music to one or more devices (e.g. speakers, a DAW, a physical instrument, a visual output, etc.) via communication interface(s) 810, described below. In an embodiment, the synchronized generated LM music is output by output thread 130. In an embodiment, the synchronized generated LM music may be output to a future scheduler on another device (not shown). Here, the synchronized generated LM music may be transmitted over a network, as described below. Here, the synchronized generated LM music may be transmitted as sequences of musical events/notes as they are generated, not just as individual notes in real-time as they are played. This allows for latency mitigation where a network/internet can add a delay in communication between two or more computing devices. Here, the global clock is a common time source for computing devices which allows the synchronized generated LM music to be played at the proper timing when it is eventually played by a device and/or musical instrument. In an embodiment, upon completion of processing block 216, processing may proceed to processing block 204 and/or any other processing blocks shown in flowchart 200.

In an embodiment, the musical improvisation system 120 may have a user interface (not shown) on computing device 110 (or any other computing device not shown that may communicate with computing device 110). The user interface allows for user input to control any number of factors related to the musical improvisation system 120. Here, the user interface of the musical improvisation system 120 may allow a user to input the duration of the input context window (i.e. how long of a time period the musical improvisation system 120 listens to the musical input to generate output), the duration of LM memory context window (i.e. how long of a time period the musical improvisation system 120 will maintain generated music in memory), and duration of output (i.e. how much time the musical output length will be generated by the musical improvisation system 120).

In an embodiment, the user interface of the musical improvisation system 120 may allow a user to input event triggers. In an embodiment, the user interface may allow a user to indicate what is the start trigger for the music generation of processing block 212, the user interface may allow a user to indicate what is the delta delay (Δ) (i.e. how long after the musical input should the generated music response arrive), as described above.

In an embodiment, the user interface of the musical improvisation system 120 may allow a user to input musical output information. In an embodiment, the user interface may allow a user to indicate the sampling space of future notes/music to be generated. In other words, the user may indicate via the user interface a length of time of music to be generated in response to each prompt, a length of bars of music to be generated in response to each prompt, or any other music characteristic for the generated music by the music LMs 132. In an embodiment, the user interface may allow a user to indicate the time interval between notes, duration of notes, range of notes, and/or range of note velocity in the generated music by the music LMs 132. In an embodiment, the user interface may allow a user to indicate the temperature, a parameter of the next token sampling, of the music LMs 132. For example, the lower the temperature the more conservative the model becomes at time of music generation.

In an embodiment, the user interface of the musical improvisation system 120 may allow a user to selectively preserve or store (i.e. keep for a period of time) or clear (i.e. remove immediately) previously generated music (i.e. generated music in processing block 212) of the music LMs based on a user input. In an embodiment, the user interface of the musical improvisation system 120 may allow a user to selectively preserve or store (i.e. keep for a period of time) or clear (i.e. remove immediately) previously received musical input (i.e. received musical input in processing block 204) based on a user input. In an embodiment, the user interface of the musical improvisation system may allow for changing of the input context window size (i.e. the size/length/duration of the musical input) used to generate music in processing block 212.

In an embodiment, the musical improvisation system 120 has the ability to dynamically invalidate future musical events. Here, the musical improvisation system 120 may discard and regenerate LM music in processing block 212 for the same time period. This allows the musical improvisation system 120 to control when to play the generated LM music and when to revise the generated LM music in response to a change in received musical input in processing block 204 or newly received musical input in processing block 204. This allows the musical improvisation system 120 to indicate, via the user interface, that the musical improvisation system 120 has adjusted the trajectory of the generated music in processing block 212 and rewritten future generated music. Here, the musical improvisation system 120, using the music LMs 132, is able to respond to changes in the music even if it has already generated an output that has not yet been played. In an embodiment, an additional output may be made, such as a visual output observable by a user, that indicates that the future musical events have been invalidated.

Referring now to FIG. 4, using the above described computing device flowchart, interaction strategies and music LMs (which may be fine-tuned for a particular application), a real-time architecture that facilitates seamless integration with a performer is realized. To achieve this, the system executes the following tasks, as shown in FIG. 4,: (a) receive MIDI input from the performer, assign timestamps, and convert it into musical events; (b) based on the current interaction strategy, aggregate musical events and dynamically create prompts for the music LM; (c) perform autoregressive inference using the current prompt; and (d) gather the music LM's output and schedule musical events to be played as MIDI notes. In some embodiments, the tasks may be performed in parallel. In some embodiments, at least some of the tasks may be performed in serial.

As illustrated in FIG. 4, these tasks must not only run in parallel but also syn-chronize with a global clock to minimize latency which may minimize latency and may ensure output music played in time with the input music. While real-time music processing typically addresses such challenges, applying these principles to complex machine learning algorithms is less common due to inherent latency issues. Additionally, the intricacy and tight coupling of the interaction strategies introduced above, compared to simpler tasks like continuation, add complexity to the system design. In this section, the system's architecture is detailed and the optimizations are outlined that were implemented for each step to ensure efficient performance.

In an embodiment, a proportional control algorithm, or any other suitable algorithm known in the art, may be used to align a clock of the music LMs 132 with the received clock of processing block 202.

In an embodiment, an Input Capture Thread 122 handles musical input from the performer (e.g., a MIDI keyboard), as discussed in processing block 204, and passes it, as described in processing block 206 to the Processing Thread 124. In an embodiment, the Processing Thread 124 timestamps the MIDI notes received by the Input Capture Thread 122 using the Clock Thread 128. In an embodiment, the processing thread 124 then converts these MIDI notes into musical events, as described above in processing block 206, by combining Note On and Note Off messages amongst other processes described above, and creates musical prompts according to the selected interaction strategy. In an embodiment, these prompts are then passed to the Generation Thread 126. In an embodiment, when generation needs to be reset (e.g., after 4 bars when prompting the model at regular time intervals and the regular time interval is 4 bars), the Processing Thread 124 issues a reset signal to the Generation Thread 126. In an embodiment, the Generation Thread 126 conducts iterative inferences on the music LM 132 with a dynamically adaptive context, sending generated notes to the Processing Thread 124, as discussed in processing block 206 and processing block 208 described above. In an embodiment, if necessary, the Generation Thread 126 can also send meta-signals, such as requests to invalidate previously sent notes. In an embodiment, the Processing Thread 124 collects the generated MIDI notes from the Generation Thread 126 and schedules them for play-back, where the Processing Thread 124 sends them to a virtual or hardware MIDI output for synthesis.

To achieve real-time performance, model inference must be optimized. In one model (Stanford-crfm/music-medium-800k) utilizes the transformers Python library, which is built on top of the PyTorch framework. Although the model logic can be exported to torchscript for execution in C++ via the PyTorch C++ API, the generation performance remains suboptimal in this setting. To enhance efficiency, the base model is converted to the ONNX framework, enabling optimized execution across various hardware backends. By exporting the model to ONNX, the musical improvisation system 120 benefits from graph optimizations, operator fusion, and native CUDA support through ONNX Runtime. This transition allows the system to leverage hardware accelerations beyond what is natively available in PyTorch,

In an embodiment, a 4-bit weight quantization is applied to the model using ONNX Runtime's quantization toolkit. This drastically reduces memory footprint and computational cost while maintaining inference accuracy within an acceptable range. Quantization not only reduces the size of the model in memory but also speeds up matrix multiplications, which are the primary bottlenecks in Transformer-based architectures. Finally, KV caching is applied to optimize sequential inference. Without caching, each new token generation requires reprocessing the entire input sequence, leading to unnecessary long computations. By storing and reusing attention key-value pairs from previous inference steps, subsequent token generations operate with a reduced computational burden, enabling better real-time performances.

As discussed above, the musical improvisation system 120 is a real-time system that embeds live music language models capable of generating symbolic music sequences coherent with a performer's input (i.e. a musical input). The system supports multiple interaction strategies that have been demonstrated in several public performances. However, these strategies limit expressive musical conversation by constraining tempo. form, or musical roles. Additionally, musical improvisation system 120 was extended to support more expressive, open-ended interaction through four key improvements: (1) modeling velocity, a key dimension of expression in symbolic music; (2) increasing model throughput via a ggml implementation required to accommodate the longer sequences induced by velocity modeling; (3) developing a new training modality that enables free-form call-and-response interaction across varying tempi; and (4) compensating for external MIDI output latency to ensure rhythmic coherence with the performer. Additionally, integration of other types of expressive control articulation may be used in the musical improvisation system 120 framework, such as pitch bend, modulation, and other real-time control inputs that musicians use to add expression into a performance. Together, these enhancements enable the musical improvisation system 120 to engage in natural, expressive musical conversation, eliminating key musical limitations to enable the development of future performances and installations.

While artificial intelligence methods-from early statistical models to deep learning models have long been used to create interfaces for musical performance, there has been little work exploiting the modeling capabilities of music Language Models (LMs) for real-time uses. As discussed above, musical improvisation system 120 is able to generate sequences of symbolic music in real-time in response to the live MIDI input of a human performer. The musical improvisation system 120 is one of the first systems to enable the use of large music LMs in real time through an optimized inference architecture and has been featured in multiple performances. However, because of its design and training data, it imposes constraints on the form (e.g., trading sequences of four bars), tempo, or musical role that a performer has to decide on during a performance. Collaborative improvisation between humans is sometimes described as a “musical conversation”, due to the similarity it shares with verbal interaction, such as a shared vocabulary and a capability for both participants to steer an improvised dialogue.

First, velocity, a key characteristic of expressive symbolic music sequences, was modeled. While expressive symbolic music sequences containing velocity are modeled in early architectures such as Performance RNN and Music Transformers, more recent architectures such as the GPT-2-based Anticipatory Music Transformer (AMT) sacrifice expression modeling to focus on the pre-training of base models on a larger amount of data. Here, the pretraining benefits of AMT were combined with the expressive capabilities of the original Music Transformer work.

Second, since modeling velocity requires generating more tokens, the throughput of the musical improvisation system 120's underlying music LMs were increased. In an embodiment, the ONNX Run-time was used to efficiently run ONNX model inferences in C++, allowing the models to run faster than real-time (also defined as having a “real-time factor” (RTF) greater than 1. In an embodiment, the ggml framework, another Machine Learning framework, was used which exhibits great speedup benefits.

Third, a new interaction strategy was developed that enables the human musician to perform with the musical improvisation system 120 by creating musical prompts of arbitrary length and tempo in a call-and-response modality, facilitating the musical conversation by setting clearer and more intuitive expectations. In an embodiment, this was done by collecting an expert dataset of MIDI sequences recorded on a piano with annotated calls and responses and use it to finetune an AMT model.

In an embodiment, a way for the musical improvisation system 120 to offset any MIDI output latency was implemented by scheduling generated notes to be played earlier, effectively enabling it to account for hardware- or network-induced delays in a systematic way, removing the need for alternative ways of combatting latencies as proposed in other interfaces. By doing so, this allows the musical improvisation system 120 to preserve a better rhythmic coherency and create smoother transitions when interacting with a human performer.

By incorporating at least some of the embodiments described above and below, this allows human performers and the musical improvisation system 120 to engage in expressive musical conversation, making it an optimal interface to interact with music LMs in real time.

In the MIDI protocol, velocity refers to the volume at which a note is played. A value between 0 and 127 captures the intensity of the note and enables the modeling of expressive dynamics, phrasing, and articulation. In order to effectively model velocity, the vocabulary of the model needs to be adapted to accommodate this new dimension. In an embodiment, AMT models were used, in particular the medium model with around 400M parameters, as the pretrained model for MIDI sequence generation, although skilled artisans realize any models known in the art may be used. In AMT, every note on/off pair is represented as a tuple of three tokens: an onset time tϵ{0, . . . , 9999} a duration d ϵ{0, . . . ,999}, and a note n-which combines the pitch pϵ{0, . . . , 127} with the instrument kϵ{0, . . . , 128} as n=128k+p. To add velocity information, a velocity token vϵ{0, . . . , 127} is added to each note. In an embodiment, the token is added by merging the velocity information with another token, similar to the note token, for example, be defining a duration-velocity hybrid token to be dv=128d+v. The drawbacks of this method are: the substantially increased vocabulary size of 128×1, 000 tokens (introducing many randomly initialized embeddings that need to be learned), increased training time, and decreased stability. In an embodiment, each note was encoded as a tuple of four tokens: (t, d, n, v). While this method increases the vocabulary by only 128, it reduces the number of notes from 341 to 256 that can fit within a 1, 024-token fixed context length. In order to enable the anticipation mechanism of AMT, a further 128 tokens were added for anticipated velocity. In an embodiment, the model's input embedding and output projection layers were resized accordingly, and the newly added parameters were randomly initialized before training. In an embodiment, to increase data diversity, data augmentation was also performed by scaling velocities by a random factor between 0.5 and 2.0 at a specified rate. In alternative embodiments, other models may be used that allow for the incorporation of the velocity token, and the use of AMT is not meant to be limiting.

It is important to note that, by expanding the vocabulary of the pre-trained model and changing its note representation, some of the benefits of the large pretraining on the Lakh MIDI dataset may be lost. However, transfer learning in the domain of symbolic music shows that further fine-tuning on slightly different representations can effectively help large pre-trained models learn new behaviors while keeping the original pre-training benefits. In an embodiment, these results were used to finetune a medium AMT on a new dataset using this new velocity representation and the results were satisfactory with clear musical coherence.

In an embodiment, Microsoft's ONNX Runtime was used to run model inferences. ONNX Runtime provides a portable cross-platform runtime system: it supports various backends and operating systems including NVIDIA CUDA and Linux. ONNX Runtime automatically traces the compute graph of each model, which reduces the implementation time and complexity. However, it has some disadvantages for the application. First, ONNX Runtime has become a very large framework with many features. This results in large supporting binaries and increased execution overhead. While ONNX Runtime provides binaries/shared libraries for some platforms, building the framework for other platforms (such as NVIDIA's ARM-based DGX Spark GB10 platform) takes a considerable amount of time and computation power, building on a continuous integration runner can take upwards of an hour. Additionally, ONNX Runtime does not support Apple macOS Metal acceleration well. In practice, only the ONNX Runtime CUDA backend can be used for the musical improvisation system 120.

To improve the model throughput and portability, in an embodiment the ggml framework was used. Here, ggml requires explicit implementation of the compute graph, but it has additional optimization and significantly reduced overhead. In an embodiment, the ggml was compiled into the binary packages as a set of shared libraries. Here, ggml compiles an individual shared library for each accelerated backend and CPU instruction feature set. These shared libraries are dynamically loaded at runtime. When the musical improvisation system 120 application starts, ggml scores each CPU backend option by supported features on the CPU and loads the best one. In practice, the smallest models (170M parameters) can run short generation segments with the ggml CPU backend and AMD AOCL BLAS optimization on an AMD Ryzen 9 7950X CPU. CPU backends do not perform as well on the same processor with ONNX Runtime. Additionally. ggml supports NVIDIA CUDA. Apple Metal. Vulkan and AMD ROCm backends (among others). The ggml implementation for Apple Metal allows for the musical improvisation system 120 to now perform on common Apple laptop and desktop computers.

A key consideration in designing live music models is their interaction modality. In particular, when working with autoregressive music LMs, consideration needs to be taken as to when the model will be prompted, when it will be refreshed, and when it will respond to the human agent. As described above and below, five interaction strategies were designed to control when the model should be prompted: (1) at regular time intervals, (2) at a melodic musical gesture, (3) at a harmonic musical gesture, (4) at continuous prompting, and (5) at manual prompting upon request. These strategies all enable different kinds of interplay with the musical improvisation system 120, allowing the human performer and the AI agent to either take turns or to play at the same time.

Follow-up work experimented with giving the ability for the performer to control the start and end of musical gestures through the use of a MIDI foot switch. This enabled a more fluid musical conversation to take place between the performer and the musical improvisation system 120, allowing the performer to have more agency on the start and end of the system's generations. An observation that stemmed from this work was that the outputs of the system tended to be highly stochastic and unpredictable due to multiple factors described later. While this was sometimes seen by participants as an opportunity for creative interplay, it was also a limitation hindering the development of a natural musical conversation due to the lack of control in the human-AI handoff and in the musical roles, as well as a lack of choice in whether gestures are followed or contrasted. Further discussion below shows improvements to make this interaction more predictable and controllable.

It is hypothesized that the lack of control in the modality to be due to two main factors. First, the dataset which the model was fine-tuned on is much more diverse than the custom datasets collected and used in earlier embodiments. This makes it harder for the model to capture a specific style, making independent generations more likely to significantly differ. Second, the training of the model focuses on the task of sequence continuation, which does not necessarily align well with a performance context. When using the system, participants naively expected the musical improvisation system 120 to respond to their prompt in a similar way that a human performer would.

To improve on these shortcomings, a new model finetuning strategy was devised that explicitly allows the model to learn the call-and-response task in a way that feels natural for the performer. In an embodiment, the distribution is modeled as: p (yₜ|y_{1:t-1},x_{1:n}).

Here, x_{1:n} is a sequence of notes of length “n” that represents the performer's input (“call”), and y_{1:t-1} is a sequence of notes of length “t” that represents the model's output (“response”). Using this tokenization scheme, the call and the response are represented using two different MIDI instrument IDs (0 and 1, respectively). This effectively dedicates slices of the model's vocabulary (each with 128 tokens) to represent the notes of either instrument, enabling both musical roles to be modeled. In an embodiment, the vocabulary for the time, duration, and velocity tokens may overlap across both instruments.

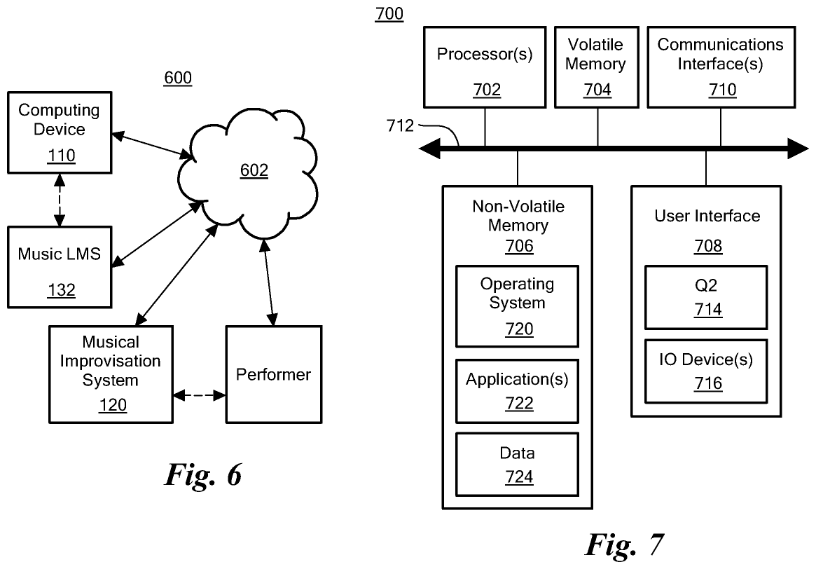

The supervised finetuning of the model on this new task requires the collection of a new dataset. Through collaboration with a performer, a dataset was collected of around 3.5 hours of solo piano, manually segmented between calls and responses. In the dataset, the performer presses on a MIDI foot switch (mapped to continuous control) when recording calls and releases it when recording subsequent responses. FIG. 6 visualizes the structure of the training data. The training data is also recorded without any specified tempo in order to avoid any future restriction when performing with the system.

In an embodiment, the musical roles of calls and responses were enforced at training time instead of expecting the musical roles to emerge at performance time. This approach is similar to the first step of the instruction tuning realized in natural language models, in which an expert labeler demonstrates a desired output behavior by crafting answers that are then used to fine-tune the model. In an embodiment, a performer acts as the expert, choreographing the musical roles of call and response at training time for the system to model effectively.

The musical improvisation system 120 aims to generate future note sequences at a faster rate than they need to be played in real-time (RTF>1). This creates an opportunity to mitigate the latency introduced by other parts of the system by scheduling MIDI messages to be played slightly earlier than their target time. In particular, this allows for offsetting latencies introduced by MIDI output devices and network connections. Physically-actuated MIDI output devices, such as a player piano, require a lead-in time to play each note. When streaming MIDI data over the internet, the network latency can be measured and compensated. Compensating for MIDI output latency is especially important when the musical improvisation system 120 outputs varying velocities. If a MIDI output device adds distinct latencies for each velocity, then the musical improvisation system 120′s intended rhythm and note ordering may be misrepresented by the output instrument. This misrepresentation is exemplified in the discussion below.

In some embodiments, two ways of offsetting the MIDI output latency of the system may be used: (1) globally and (2) individually based on pitch and velocity, as discussed above. Global latency offsets are configured from a textbox in the interface. In some embodiments, the per-note and -pitch offsets are loaded as a lookup table (LUT) from a comma-separated value (CSV) file. In some embodiments, this LUT is selected from a dropdown menu to allow for simple switching of latency profiles for different output devices.

In order to evaluate the system, two areas for which quantitative metrics, such as the throughput of the model and the latency compensation, could be retrieved were examined. In an embodiment, the throughput of the model was evaluated by measuring the number of tokens per second the model can generate during a performance setting. In an embodiment, this was measured by keeping a running average of the number of tokens generated every second and waiting for 15 seconds before reporting the value. The number of tokens per second decreases with time as the context window fills up and plateaus once it is filled. In an embodiment, a maximum context window of 120 tokens for the model was used that corresponds to 40 notes without velocity and 30 notes with velocity. In an embodiment, the latency of the model, defined as the time it takes for the model to generate a single token, in milliseconds, was calculated by multiplying the inverse of the number of tokens per second by 1000.

In an embodiment, the performance difference between the ONNX Runtime implementation and the ggml implementation was compared and run the models using CPU (AMD Ryzen 9 7950X). CUDA GPU (NVIDIA RTX 4090), and Apple Metal (M3 Max MacBook Pro) backends. In an embodiment, the performance of a model finetuned on a small pre-trained AMT model (with a parameter count of 170M parameters) and another model finetuned on a medium pre-trained AMT model (with a parameter count of 416M parameters) was tested. The results are in Tables 1 and 2, shown below. It was observed that the use of ggml improves the model throughput by a factor of 2 for both model sizes when using CUDA. Ggml and also improves model throughput when using CPU to a lesser extent. In an embodiment, the ggml also allows the models to be run on Apple accelerated AI hardware through an implementation of operators using the Metal framework, opening the door for wider adoption of the system.

TABLE 1
170M Parameter Model Throughput

| Framework | Backend | Latency(ms)↓ | Tokens/second↑ |
|---|---|---|---|
| ONNX | CUDA | 4 | 249.75 |
| ggml | CUDA | 2 | 499.5 |
| ggml | Metal | 10.13 | 98.76 |
| ONNX | CPU | 54.83 | 18.24 |
| ggml | CPU | 33.45 | 29.90 |

CUDA: NVIDIA RTX 4090; CPU: AMD Ryzen 9 7950X; Metal: M3 Max MacBook Pro

TABLE 2
416M Parameter Model Throughput

| Framework | Backend | Latency(ms)↓ | Tokens/second↑ |
|---|---|---|---|
| ONNX | CUDA | 8.01 | 124.84 |
| ggml | CUDA | 4.04 | 247.65 |
| ggml | Metal | 26.17 | 38.21 |
| ONNX | CPU | 118.55 | 8.44 |
| ggml | CPU | 100.17 | 9.98 |

CUDA: NVIDIA RTX 4090; CPU: AMD Ryzen 9 7950X; Metal: M3 Max MacBook Pro

Referring now to FIG. 6, a system for real-time, AI driven musical interaction may be implemented over a network (e.g. the internet) or in a cloud computing environment 600 (which may also be referred to as a cloud environment, cloud computing or cloud network). A cloud computing environment can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 600, one or more clients (such as computing device 110, music LMs 132, musical improvisation system 120, or any other computing devices as discussed above) are in communication with the cloud network 602 and/or in communication with each other via the cloud network 602. The cloud network 602 may include back-end platforms, e.g., servers, storage, server farms and/or data centers. The one or more clients may be associated with a single organization (where a single organization may be considered a single performer such as a single musician or a single band, for example, that provides a musical input) or multiple organizations (where a multiple organizations may be considered multiple performers such as multiple musicians or multiple bands, for example, that provide one or more musical inputs). In one example implementation, the cloud computing environment 600 may provide a private cloud serving a single organization (e.g., an enterprise cloud serving a single musician or a single band that provide a musical input). In another example, the cloud computing environment may provide a community or public cloud serving multiple organizations (e.g. a cloud serving multiple performers such as multiple musicians or multiple bands that providence or more musical inputs).

In some embodiments, a gateway appliance(s) or service (not explicitly illustrate in FIG. 6) may be utilized to provide access to cloud computing resources and virtual sessions in the cloud network 602. Such a gateway appliance(s) or service may be deployed on-site with a performer (e.g. on a stage, concert hall, stadium or other structure or premises where the performer performs) or on public clouds to provide users (i.e. one or more performers) with secure access and single sign-on to virtual, SaaS, web applications or any other services provided by cloud network 602. Furthermore, to protect users from web threats, a secure gateway may be used.

In still further embodiments, the cloud computing environment 600 may provide a hybrid cloud that is a combination of a public cloud and a private cloud. Public clouds may include public servers that are maintained by third parties to the clients or the organization(s). The servers may be located in geographical locations which are remote from the performer and/or cloud clients.

The cloud computing environment 600 can provide resource pooling to serve multiple users (e.g. performers) via clients with different physical and virtual resources dynamically assigned and reassigned responsive to different demands for the respective users. Such a cloud computing environment 600 can include a system or architecture that can provide a single instance of software, an application or a software application to serve multiple users. In some embodiments, the cloud computing environment 600 can provide on-demand self-service to unilaterally provision computing capabilities (e.g., server time, network storage) across a network for multiple users (i.e. performers). By way of example, provisioning services may be provided through software-streaming technology that delivers patches, updates, and other configuration information to multiple virtual endpoints through a shared image. The cloud computing environment can provide an elasticity to dynamically scale out or scale in response to different demands from users (i.e., one or more performers). In some embodiments, the cloud computing environment 600 may include or provide monitoring services to monitor, control and/or generate reports corresponding to the provided shared services and resources.

In some embodiments, the cloud computing environment 600 may provide cloud-based delivery of different types of cloud computing services, such as Software as a Service (Saas), Platform as a Service (PaaS), Infrastructure as a Service (IaaS), and Musical Improvisation as a Service (MIaaS). For example. MIaaS may refer to a performer renting the use of infrastructure resources that are needed during a specified time period (e.g. during a performance) for performing any of the processing block(s)/decision block(s) of flowchart 200. MIaaS providers may offer storage, networking, servers or virtualization resources from large pools, allowing the users to quickly scale up by accessing more resources as needed.

PaaS providers may offer functionality including, but not limited to storage, networking, servers or virtualization, as well as additional resources such as, e.g., the operating system, middleware, or runtime resources.

SaaS providers may offer the resources that PaaS provides, including storage, networking, servers, virtualization, operating system, middleware, or runtime resources. In some embodiments, SaaS providers may offer additional resources including, e.g., data and application resources.

Similar to SaaS, DaaS (which is also known as hosted desktop services) is a form of virtual desktop infrastructure (VDI) in which virtual desktop sessions are typically delivered as a cloud service along with the apps used on the virtual desktop.

Any of the above-referenced services (i.e. MIaaS, SaaS, Paas, Iaas, and/or Daas) may provide any number of resources for implementation of musical improvisation system 120 or any of the threads of musical improvisation system 120.

Referring now to FIG. 7, a computing system 700, such as computing device 110, may include one or more processors 702, volatile memory 704 (e.g., RAM), non-volatile memory 706 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 708, one or more communications interfaces 710, and a communication bus 712. The user interface 710 may include a graphical user interface (GUI) 714 (e.g., a touchscreen, a display, etc.) and one or more input/output (I/O) devices 716 (e.g., a mouse, a keyboard, etc.). The non-volatile memory 706 may store an operating system 720, one or more applications 722 (e.g., musical improvisation system 120), and data 724 such that, for example, computer instructions of the operating system 720 and/or applications 722 are executed by the one or more processors 702 out of the volatile memory 706. Data may be entered using an input device of the GUI 714 or received from I/O device(s) 716. Various elements of the computing system 700 may communicate via communication bus 712. The computing system 700 as shown in FIG. 7 is shown merely as an example, of computing devices as the processing described herein may be implemented by any computing or processing environment and with any type of machine or set of machines that may have suitable hardware and/or software capable of operating as described herein.

The one or more processors 702 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, graphical processing units (GPUs), neural processing units (NPUs), any hardware for artificial intelligence inferencing, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 710 may include one or more interfaces to enable the computing device 110 to access a computer network such as a LAN, a WAN, or the Internet through a variety of wired and/or wireless or cellular connections.

As noted above, in some embodiments, one or more computing systems 700 may execute an application on behalf of a user of a client computing device, may execute a virtual machine, which provides an execution session within which applications execute on behalf of a user or a client computing device, such as pedal, may execute services to provide a hosted environment, or may provide access to a computing environment including one or more of: one or more applications, one or more devices applications in which one or more applications may execute.

Various embodiments of the concepts, systems, devices, structures and techniques sought to be protected are described. It should, however, be appreciated that alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

The following definitions and abbreviations are to be used for the interpretation of the claims and the specification. As used herein, the terms “comprises,” “comprising”, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus. Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “direct contact” means that a first element and a second element, are connected without any intermediary elements at the interface of the two elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the concepts, upon which this disclosure is based, may readily be utilized as a basis for the designing of other structures, methods, and systems for carrying out the several purposes/functions of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method for real-time artificial intelligence (AI) driven musical interaction, the method comprising:
receiving a global clock;
receiving one or more musical input signals;
processing the one or more musical input signals using the global clock to generate one or more musical events;
updating one or more music language models (LMs) based on the generated one or more musical events;
responsive to triggering a prompt, generating LM musical output using at least a portion of the one or more musical events and the one or more music LMs;
synchronizing generated LM musical output based on the global clock; and
outputting the synchronized generated LM musical output.

2. The method of claim 1, wherein the one or more music LMs generate the LM musical output using autoregressive generation.

3. The method of claim 1, wherein the generated LM musical output is an audio output.

4. The method of claim 1, wherein the generated LM musical output is one or more musical events.

5. The method of claim 4, wherein the one or more musical events is one or more notes.

6. The method of claim 1, wherein the prompt is a time interval.

7. The method of claim 6, wherein the time interval is one or more bars.

8. The method of claim 1, wherein the prompt is a musical gesture.

9. The method of claim 8, wherein the musical gesture is a root note.

10. The method of claim 1, wherein the prompt is a user input.

11. A system for real-time artificial intelligence (AI) driven musical interaction, the system comprising:
one or more processors for receiving a global clock;
one or more processors for receiving one or more musical input signals;
one or more processors for processing the one or more musical input signals using the global clock to generate one or more musical events;
one or more processors for updating one or more music language models (LMs) based on the generated one or more musical events;
one or more processors for determining a prompt, and responsive to triggering the prompt, generating LM musical output using at least a portion of the one or more musical events and the one or more music LMs;
one or more processors for synchronizing generated LM musical output based on the global clock; and
one or more processors for outputting the synchronized generated LM musical output.

12. The system of claim 11, wherein the one or more music LMs generate the LM musical output using autoregressive generation.

13. The system of claim 11, wherein the generated LM musical output is an audio output.

14. The system of claim 11, wherein the generated LM musical output is one or more musical events.

15. The system of claim 14, wherein the one or more musical events is one or more notes.

16. The system of claim 11, wherein the prompt is a time interval.

17. The system of claim 16, wherein the time interval is one or more bars.

18. The system of claim 11, wherein the prompt is a musical gesture.

19. The system of claim 18, wherein the musical gesture is a root note.

20. The system of claim 11, wherein the prompt is a user input.
